(19) United States
(12) Patent Application Publication
(10) Pub. No.: US 2013/0166366 A1
(43) Pub. Date: Jun. 27, 2013

(54) Meal planning and coupon dispensing

(71) Applicant: Commodore Allen, Edmonton (CA)

(72) Inventor: Commodore Allen, Edmonton (CA)

(21) Appl. No.: 13/374,336

(22) Filed: Dec. 22, 2011

(51) Int. Cl. G06Q 30/02; G06Q 30/06

(52) U.S. Cl. 705/14.25; 705/14.39

(57) ABSTRACT

Meal planning and coupon dispensing are provided. An electronic-shopping list is created. Store-specific data is procured from third-party store websites. The store-specific data is added to the electronic-shopping list. Recipes from third-party websites are saved. The third-party recipes are parsing for ingredients. The ingredients are added to the electronic-shopping list. Manufacturer and/or coupon publisher websites are analyzed for coupons. Items on the electronic-shopping list are analyzed to maximize savings through the use of manufacturer coupons. Recipe ingredients are analyzed to maximize savings through the use of manufacturer coupons and store sales items. Recipes are ranked by the number of discounted ingredients they contain. An in-store navigation map includes an in-store application interface. Thus, an integrated approach for shopping list, coupon, and recipe management is provided.

### FIELD OF THE INVENTION

The present invention relates to methods, systems, and apparatus to manage meal planning and coupon dispensing.

### BACKGROUND OF THE INVENTION

The Internet is a global network of computers. Network servers support hypertext capabilities that permit the Internet to link together websites. User interfaces such as Graphical User Interfaces (GUI) are typically used to navigate the Internet to retrieve relevant websites. Uniform Resource Locators (URLs) are used to identify specific web sites and web pages on the Internet. URLs also identify the address of the website to be retrieved from a network server. The Transfer Control Protocol/Internet Protocol (TCP/IP) is used to transfer information.

The Internet uses a hypertext language referred to as the hypertext mark-up language (HTML). HTML is a commonly used scripting or programming language that permits content providers or developers to place hyperlinks within web pages. These hyperlinks link related content or data, which may be found on multiple Internet-host computers. HTML document links may retrieve remote data by use of HyperText Transfer Protocol (HTTP). When a user clicks on a link in a web document, the link icon in the document contains the URL that the client application employs to initiate the session with the server storing the linked document. HTTP is the protocol used to support the information transfer.

While most of today's users of the Internet believe it is a recent communications phenomenon, the origins of the Internet actually go back several decades. Today's Internet grew out a computer resource-sharing network created in the 1960s by the Advanced Research Projects Agency (ARPA). This computer resource-sharing network, which came to be known as the ARPAnet, was primarily designed by ARPA's chief scientist, Larry Roberts. The initial problem facing a wide-area computer resource-sharing network was how to efficiently transmit digitized information in a reliable way. To solve this problem, in 1968, Roberts mandated use of a packet-switching design in the ARPAnet.

Packet switching breaks up blocks of digitized information into smaller pieces called packets. These packets are transmitted through the network, usually by different routes, and are then reassembled at their destination. Eight years prior to ARPA's Request for Proposal, Len Kleinrock invented packet switching. See, e.g., Len Kleinrock, “Information Flow in Large Communications Nets,” RLE Quarterly Progress Report (1960); Len Kleinrock, Communication Nets (1964). See also Paul Baren, “On Distributed Communications Networks,” IEEE Transactions on Systems (March 1964). Roberts believed that packet switching was the means to efficiently transmit digitized information in a reliable way.

The next problem to solve was how to interconnect a number of mainframe computers, most of which utilized different languages and different operating systems. Wesley Clark of Washington University in St. Louis, Mo. devised the solution to this huge incompatibility problem. Clark proposed that a smaller microcomputer should interface between every mainframe and the network. All of these minicomputers would run on the same operating system and use the same language. Each mainframe, therefore, would only be required to interface with its own minicomputer, with the minicomputer translating into the network operating system and language. These Interface Message Processors (IMP), which provided an interface between the ARPAnet host mainframe computers and the ARPAnet, were the predecessors to today's routers. With this basic design, the first two nodes on the ARPAnet communicated on 1 Oct. 1969.

By 1971, 15 nodes, mostly academic institutions, were up on the ARPAnet; however, the original goal of the ARPAnet was not being realized. Resource sharing of the mainframe computers was simply too cumbersome. In March 1972, Ray Tomlinson of consulting firm Bolt, Beranek & Newman invented e-mail. Use of this message transfer program quickly grew to be the initial major use of the ARPAnet.

By the mid-seventies, the ARPAnet was not the only network utilizing switching packets. Once again, an incompatibility problem emerged. Each of these different networks used a different protocol. Thus, interconnection of these different networks was not possible. The solution, devised by Robert Kahn of ARPA and Vincent Cerf of Stanford University, was called the Transmission Control Protocol/Internet Protocol. The Transmission Control Protocol packetized information and reassembled the information upon arrival. The Internet Protocol muted packets by encasing the packets between networks. See, e.g., Robert Kahn and Vincent Cerf, “A Protocol for Packet Network Intercommunication,” IEEE Transactions on Communications Technology (May 1974). Transmission Control Protocol/Internet Protocol was adopted by the ARPAnet in 1983. With the addition of the Domain Name System (DNS) in November 1983, the now familiar Internet address protocol was established.

A final step in creating the Internet occurred in 1990, when an Englishman, Tim Berners-Lee working at the European Center for Particle Research (CERN) in Switzerland, invented the World Wide Web. This software, based on a program Berners-Lee had written in 1980 to allow users to store information using random associations, allowed material from any computer, from any format to be translated into a common language of words, images, and addresses. Bemers-Lee's program established the three core components of the World Wide Web: the Universal Resource Locator, Hypertext Transfer Protocol, and HyperText Markup language.

More recent innovations include: the founding in October 1994 by Tim Berners-Lee of the World Wide Web Consortium (W3C), an international community where member organizations, a full-time staff, and the public work together to develop Web standards; the introduction in December 1995 of the JavaScript species of ECMAScript, developed by Brendan Eich of Netscape, a prototype-based, object-oriented scripting language; the introduction on 26 Jan. 2000 by the W3C of the eXtensible HyperText Markup Language (XHTML), a family of XML markup languages that mirror or extend versions of the HTML; the development from 2000-20002 of the XMLHttpRequest, an application programming interface (API) available in web browser scripting languages used to send HTTP or HTTPS requests directly to a web server and load the server response data directly back into the script; the founding in 2004 of the Web Hypertext Application Technology Working Group (WHATWG), a community of people focusing on the development of HTML and APIs needed for Web applications; and the ongoing development of the latest revision of the HTML standard, HTML5.

Most grocery retailers offer weekly sales specials. Generally, grocery retailers will post sales on their web pages. Many of the retailers use a flash or HTML module design for their sale items on the sales page. When a user scrolls over an item, the module enlarges. A user can add the items to a shopping list directly from the module. A user can change the quantity of the items they wish to purchase. After the list is finished it can be printed or e-mailed. Some grocery retailers post a few manufacturer coupons and recommended recipes, etc. Manufacturer coupons can be added to the shopping list as a sales item. The recommended recipes often are sponsored by product manufacturers. A user can add the ingredients to the shopping list. After the list is finished it can be printed or e-mailed. An example of such grocery retailer's web page can be found at http://www.albertsons.com/ (accessed 16 Dec. 2011). This is the website of Supervalu Inc. d/b/a as Albertsons, 1840 Valley View Road, Eden Prairie, Minn. 55344.

In addition to recipes on grocery retailer's web pages, there exist a plethora of website dedicated to food that include recipes. For example, Rachael Ray is a popular cooking celebrity. Her website, http://www.rachaelray.com/(accessed 16 Dec. 2011), also offers recipes. Visitors to her site can print and e-mail her recipes. If a user wishes to buy the ingredients to a recipe, however, the user must manually add these ingredients to their grocery list.

### SUMMARY OF THE INVENTION

In accordance with the principles of the present invention, methods, systems, and apparatus to manage meal planning and coupon dispensing are provided. An electronic-shopping list is created. Store-specific data is procured from third-party store websites. The store-specific data is added to the electronic-shopping list. Recipes from third-party websites are saved. The third-party recipes are parsing for ingredients. The ingredients are added to the electronic-shopping list. Manufacturer and/or coupon publisher websites are analyzed for coupons. Items on the electronic-shopping list are analyzed to maximize savings through the use of manufacturer coupons and/or coupon-publisher coupons. All recipes and their ingredients are analyzed to maximize savings through the use of manufacturer coupons, coupon-publisher coupons, and store-specific sales items. An in-store navigation map includes an in-store application interface. Thus, an integrated approach for shopping list, coupon, and recipe management is provided.

### BRIEF DESCRIPTION OF THE DRAWINGS

FIG. 1 is a block diagram of an example shopping-list-item-procurement module in accordance with the principles of the present invention.

FIG. 2 is a block diagram of an example shopping-list-savings-optimization module in accordance with the principles of the present invention.

FIG. 3 is a block diagram of an a example in-store-experience module in accordance with the principles of the present invention.

FIG. 4 is a screen shot showing an example in-store navigation map in accordance with the principles of the present invention.

FIG. 5 is a flow chart showing an example process flow from the perspective of the user in accordance with the principles of the present invention.

FIG. 6 is a block diagram of data flow in accordance with the principles of the present invention.

FIG. 7 is a non-limiting example of a hardware infrastructure that can be used to run a system that implements the present invention.

### DETAILED DESCRIPTION OF PREFERRED EMBODIMENTS

The present invention provides an integrated approach for providing shopping list, coupon, and recipe management as a mobile-device application. The present invention includes means to procure store-specific data such as sales items and coupons from third-party store websites and add them to an electronic shopping list. The present invention also provides the ability to save recipes from third-party websites, parse them for ingredients, and add the ingredients to the electronic shopping list. Items on a shopping list are analyzed to maximize savings through the use of manufacturer coupons and coupon-publisher coupons, and verification of coupon/savings requirements. The present invention uses analytics and heuristics to analyze the electronic shopping list and past purchases to recommend additional products. The present invention includes means to procure store-specific data such as sales items and coupons for individual recipe ingredients. The system will also search, sort, and display recipes with the most discounted ingredients. While in-store, the present invention provides navigation through interactive store maps, and makes recommend off-list items based on the analysis of the electronic shopping list and/or past purchases and location within the store.

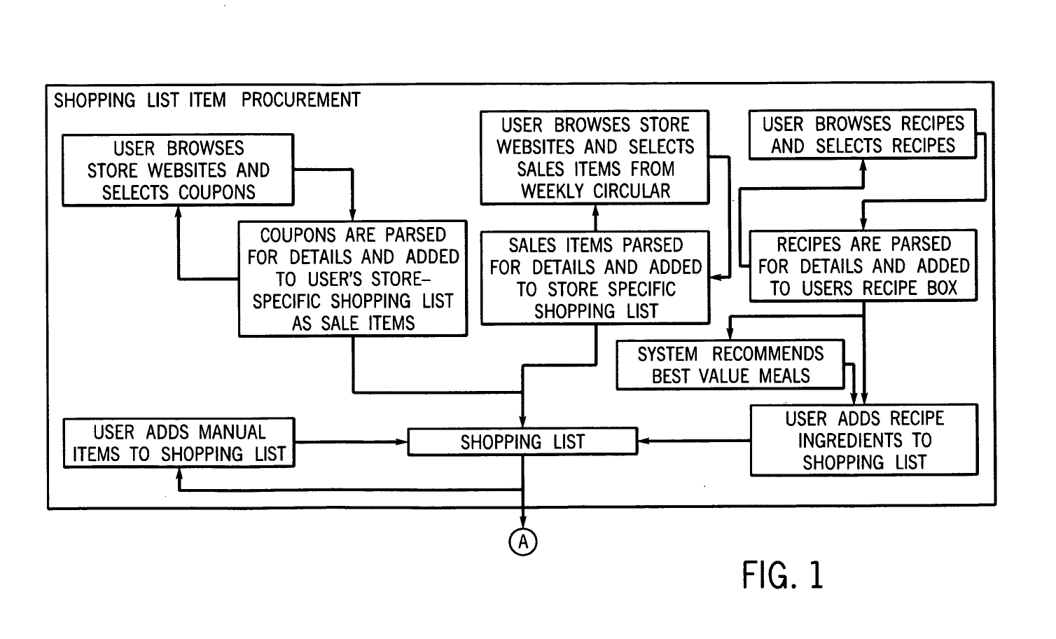

Referring to FIG. 1, block diagram of an example shopping-list-item-procurement module in accordance with the principles of the present invention is seen. The shopping-list-item-procurement module acts as an interface between the system and third-party websites containing sales items, coupons and/or recipes. An electronic shopping list is created. A user can browse store websites for coupons and/or sale items. The coupons are parsed for details. The details of coupons/sale items can be extracted, such as the total savings and any conditions that must be met before the coupon is valid. The details are added to user's store-specific electronic-shopping list as sale items. The user also can browse recipe websites for recipes and select recipes. Recipe ingredients are parsed for coupons and store specific sales items. Recipes are analyzed, sorted and ranked by the number of discounted ingredients. The user can select recipes with the most discounted ingredients and then be given the option to add all ingredients or a subset to their electronic-shopping list. In the case of recipes, ingredients can be extracted and the user can be given the option to add all ingredients or a subset to their electronic-shopping list.

The system can calculate weekly “best-value meals” based off the user's recipe box, store circular sales items, and manufacturer, coupon-publisher, and store coupons. The system may display best value meals based on the total aggregate savings of the ingredients or the recipe with the total minimum cost. The user can add the ingredients for a best value recipe in the same way of a normal recipe. As coupons and sales items rotate weekly (or more, depending on store and manufacturer/coupon-publisher coupons), best value meals will vary depending on the currently available savings.

The user also can manually add items, which don't appear as sale items or recipe ingredients, to their electronic-shopping list. The system can retain shopping list history allowing the user to either select a complete historical shopping list or select individual items off of a historical list. The manual item entry interface may sort previous shopping list items by frequency of purchase to save the user from having to manually enter the items or search through the complete historical list.

Based on the analysis of past purchase habits, the system can recommend products of which the user may be running out. These alerts can be in the form of reminders while the user is creating their shopping list or while the user is in-store. For example: if the system detects that the user normally purchases laundry detergent in an approximate period of 30 days, and it has been 30 days since the last purchase, the system can recommend that the user add laundry detergent to their shopping list. During the in-store experience, the system may preferentially display sale items on which the user may be running low, even if the purchase period for the item has not been reached. This allows the user to optimize their savings by purchasing sale items before they run out of a product.

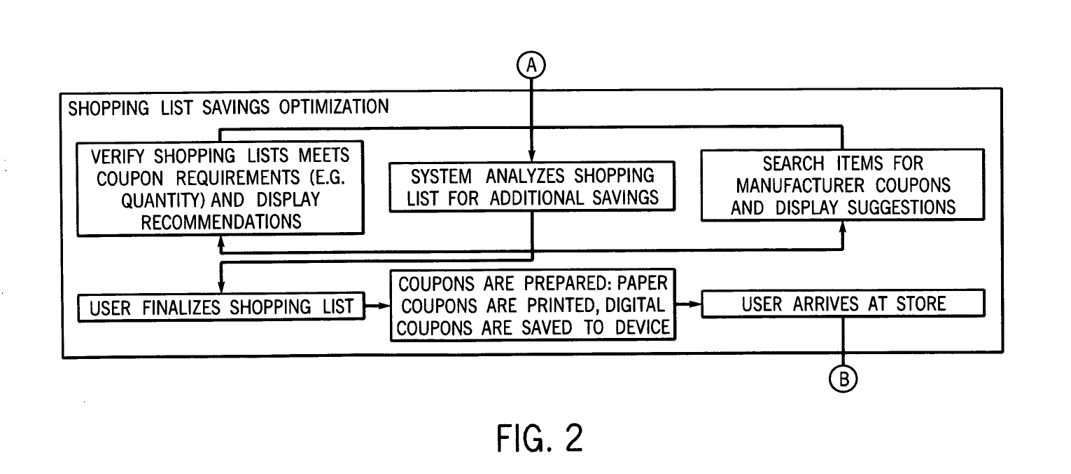

Referring now to FIG. 2, a block diagram of an example shopping-list-item-procurement module in accordance with the principles of the present invention is seen. The shopping-list-item-procurement module analyzes electronic-shopping list for additional savings. The electronic-shopping list is reviewed to verify that it meets coupon requirements (for example, quantity) and recommendations are displayed. The electronic-shopping list is analyzed for additional savings. The system searches manufacturer-coupon and coupon-publisher databases to locate coupons that match the items in the list. Recipe ingredients are analyzed to maximize savings through the use of manufacturer coupons, coupon-publisher coupons, and store sales items. Recipes are ranked by the number of discounted ingredients they contain. Coupons that match sale items exactly can be automatically added. For example, for a specific brand and offering of detergent that appears on the electronic-shopping list, coupons can be automatically located and included morn The user finalizes their electronic-shopping list. For generic and/or non-sales items that have manually been added—such as milk, produce or vitamins—the system can display any matching coupons as suggestions. These suggestions can be in the form of a specific brand and offering that has a corresponding manufacturer/coupon-publisher coupon. The electronic-shopping list can be checked to ensure that the items and quantities match the coupon requirements. For example, if a coupon or sales item requires a minimum quantity to be purchased, the system can recommend the user increase the quantity indicated on their electronic-shopping list to the minimum level. Likewise, if a coupon or sales item requires a companion product to be purchased at the same time, the system can recommend the addition of this second product to their electronic-shopping list. Coupons are prepared: the system offers to print paper coupons and downloads digital coupons to the local database for offline access. The user goes shopping.

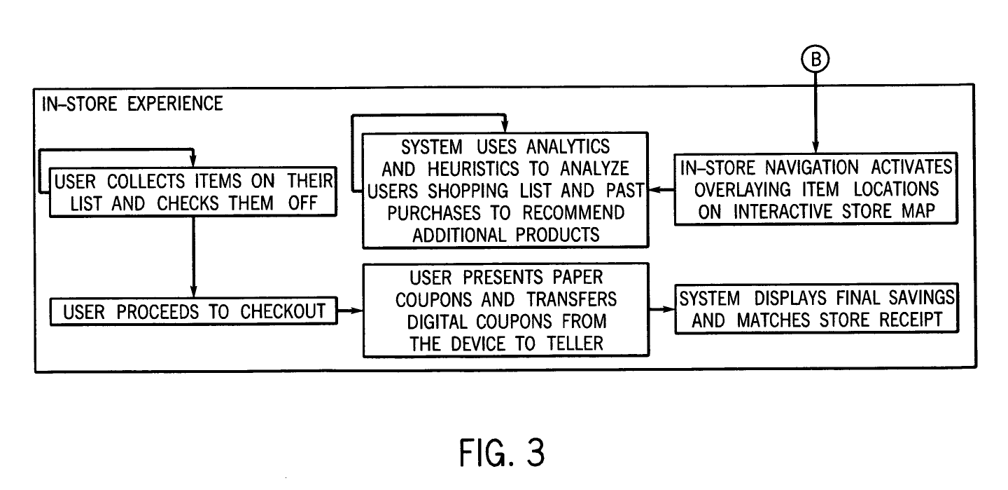

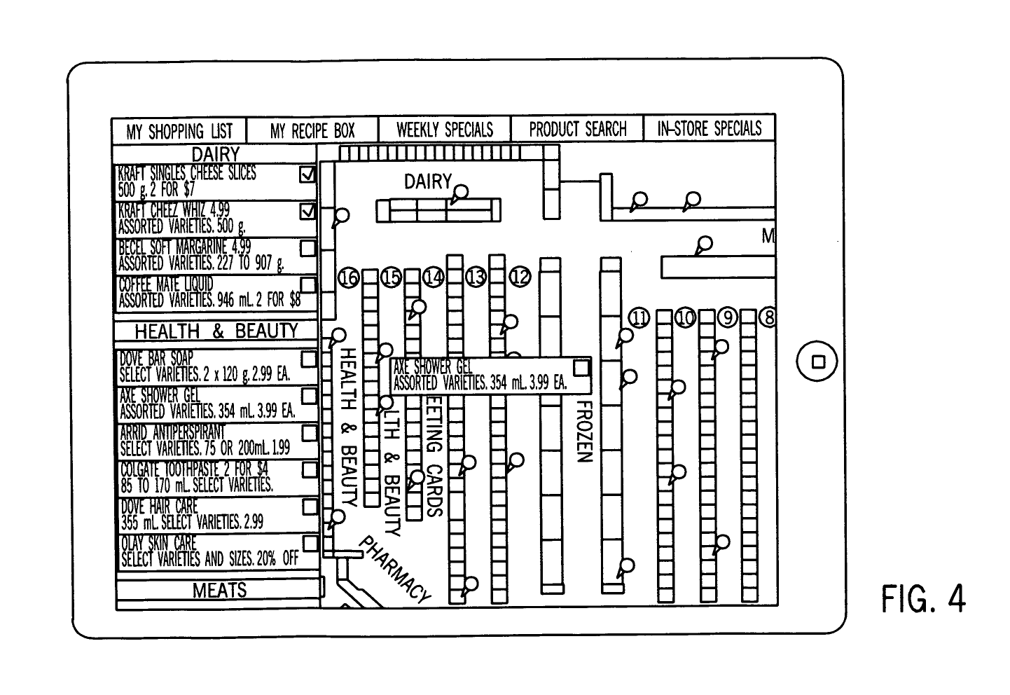

FIG. 3 is a block diagram of an example in-store-experience module in accordance with the principles of the present invention. FIG. 4 is a screen shot showing an example in-store navigation map in accordance with the principles of the present invention. Referring to FIG. 3 and FIG. 4, the in-store-experience module creates an interactive in-store navigation map. This interactive in-store navigation map may be displayed on a wireless telephone, a personal computer, a personal digital assistant (PDA), a lap top computer, or another type of computation or communication device. The in-store-experience module activates overlaying shopping-list item locations on the interactive in-store navigation map. The interactive in-store navigation map includes an in-store application interface. When arriving at a store, the system can display a map of the specific store, overlaid with the locations of the products on the user's electronic-shopping list. From the in-store application interface, the user can access electronic-shopping list, recipe box, store's weekly specials, product searches, in-store specials, and the like.

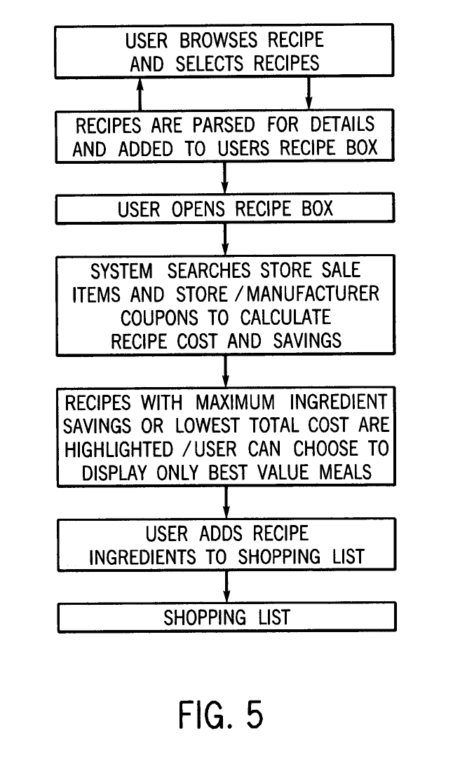

FIG. 5 is a flow chart showing an example process flow from the perspective of the user in accordance with the principles of the present invention. The user browses and selects recipes. The selected recipes are parsed for details and added to the user's recipe box. The user opens their recipe box. The system searches store sale items, coupon-publisher coupons, and manufacturer coupons to calculate recipe costs and savings. Recipes with maximum ingredients savings or lowest total costs are highlighted. The user can choose to display only best value meals. The user adds recipe ingredients to the shopping list. The shopping list is utilized for shopping.

The system uses analytics and heuristics to analyze the electronic-shopping list and past purchases to recommend additional products. Based on the user's past purchasing decisions, location within the store, and products on their electronic-shopping list, the system can display related sale items that may be of interest to the user For example, if the user has coffee filters on their electronic-shopping list and their profile indicates they prefer a specific style of coffee, the system could alert them to a coffee-brand sale item matching their preference and highlight the product location on the store map. The user can then choose to add the product to their electronic-shopping list. The user collects items on their electronic-shopping list and checks them off on the in-store navigation map or shopping list. As the user indicates that they have acquired a product, the corresponding map marker disappears. The user proceeds to checkout. The user presents paper coupons and transfers digital coupons from the device to a teller. The user can transfer digital coupons to the teller either by scanning the mobile device's display or wireless or wired technologies. The system can display final savings and matches store receipt.

The modules may have direct integration with third party systems through the use of an API. Site-specific scrapers, running on remote servers, can extract relevant information from third-party web pages and store it in an intermediate database in a format that is easily presentable to the system. Site-specific scrapers, running in an application, extract relevant information and store it directly in the user's database. Passing of information from the third-party website to the user database may be facilitated by the direct use of the system to browse third party sites, a browser plug-in, direct data sharing (such as API's) negotiated through partnerships, or HTML scraping by the system or supporting server. Several information procurement methods can be utilized to accommodate third party providers of differing investment and technological maturity.

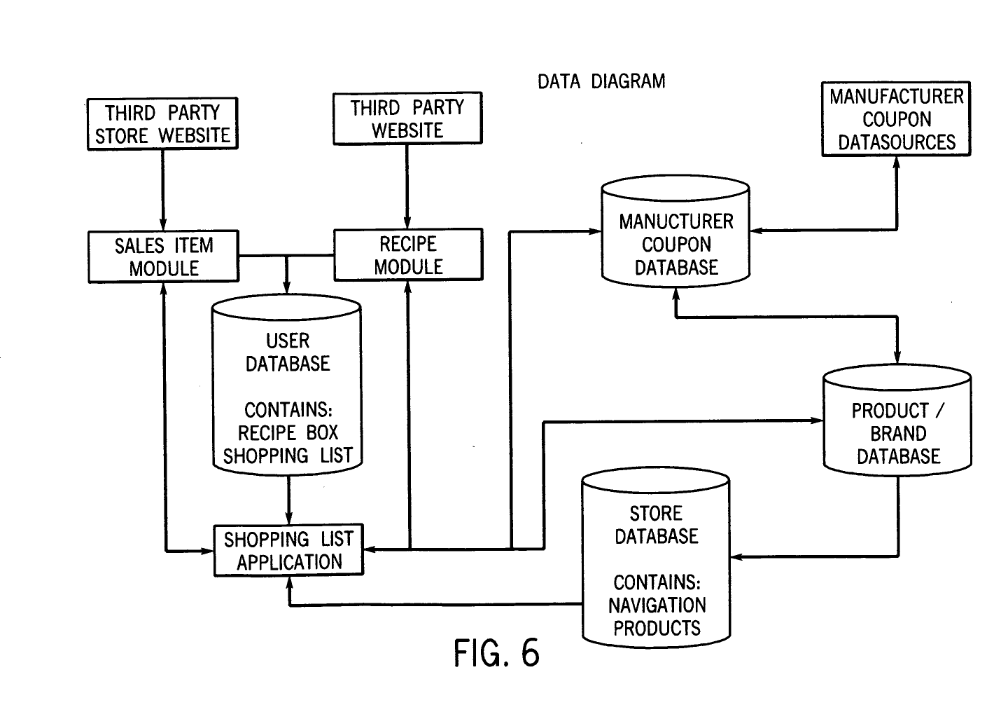

FIG. 6 is a block diagram of an example data flow in accordance with the principles of the present invention. A user database is provided. The user database contains the user's electronic-shopping lists, recipe box, and any other information readily needed by the system. While the user database can be stored on the device or on remote servers, in one embodiment the user database is stored on a combination of the device and remote servers. Local storage allows the system to be used in locations where connectivity is intermittent or absent. For example, in stores that do not provide WiFi, on WiFi-only devices connectivity can be intermittent or absent. Local storage also provides responsiveness to the user when using the system on a slow connection such as some cellular networks. Remote storage provides redundancy in the event that the user's device is lost, stolen or damaged. Remote storage allows constant access to the user's data for data-mining, heuristic, and analysis purposes. A synchronization mechanism can be used to synchronize the on-device database with the remote database.

A manufacturer-coupon database/datasource is provided. The manufacturer-coupon database/datasource is responsible for providing a list of relevant manufacturer coupons to the system. The manufacturer-coupon database/datasource is connected to manufacturer-coupon datasources. The manufacturer-coupon database/datasource can be kept up to date through interfacing with third party services or manufacturer systems directly. The manufacturer-coupon database/datasource also can be responsible for providing a list of relevant coupon-publisher coupons to the system.

A store database is provided. The store database contains listing of store products to be used for in-store marketing. The store database also contains locations of products and data to provide in in-store navigation. A product/brand database is provided. The product/brand database is connected to the store database and the manufacturer-coupon database. The product/brand database provides a master-list of products and brands. The product/brand database is used to correlate coupons, sales items, and store products

A shopping-list application can be connected to the user database, the manufacturer-coupon database/datasource, the store database, and the product/brand database. Users can undergo some form of registration prior to using the system. Registration identifies them to the remote system where their user database is stored. Registration also uniquely identifies users for profiling and data-mining; provided, however, this user ID is preferably anonymized and not connected with user names that are assigned to each individual user to keep user identities private. In addition, users could “opt-in” to the system to experienced this improved user experience; alternatively, users could “opt-out” of this system as well.

The shopping-list application also can be connected to a sales-item module and recipe module. The sales item module receives sales-item input from a third-party store website. The recipe module receives recipes off third-party site, determine the ingredients, and allow the user to save the recipe into their recipe box. The sales-item module and recipe module also provide input to the user database.

Thus, in accordance with the principles of the present invention, two completely divergent and separate publishers of content are combined into a completely new application. This is evidenced in the following non-limiting example:

### EXAMPLE

As reference in the Background, Supervalu Inc. d/b/a as Albertsons, 1840 Valley View Road, Eden Prairie, Minn. 55344 has a website that can be found at http://www.albertsons.com/ (accessed 16 Dec. 2011). Rachael Ray, a popular cooking celebrity, has her website at http://www.rachaelray.com/ (accessed 16 Dec. 2011). Albertsons' website offers sponsored recipes in which their customers can add ingredients from the recipe into their electronic-shopping list. Rachael Ray's website is one of a plethora of websites that offer recipes. By utilizing the present invention, viewers can save her recipes to the recipe box. The same recipe box can also be found on the user's favorite grocery store web site, such as Albertsons. A user can then add the ingredients of Rachael Ray's recipes into their electronic-shopping list.

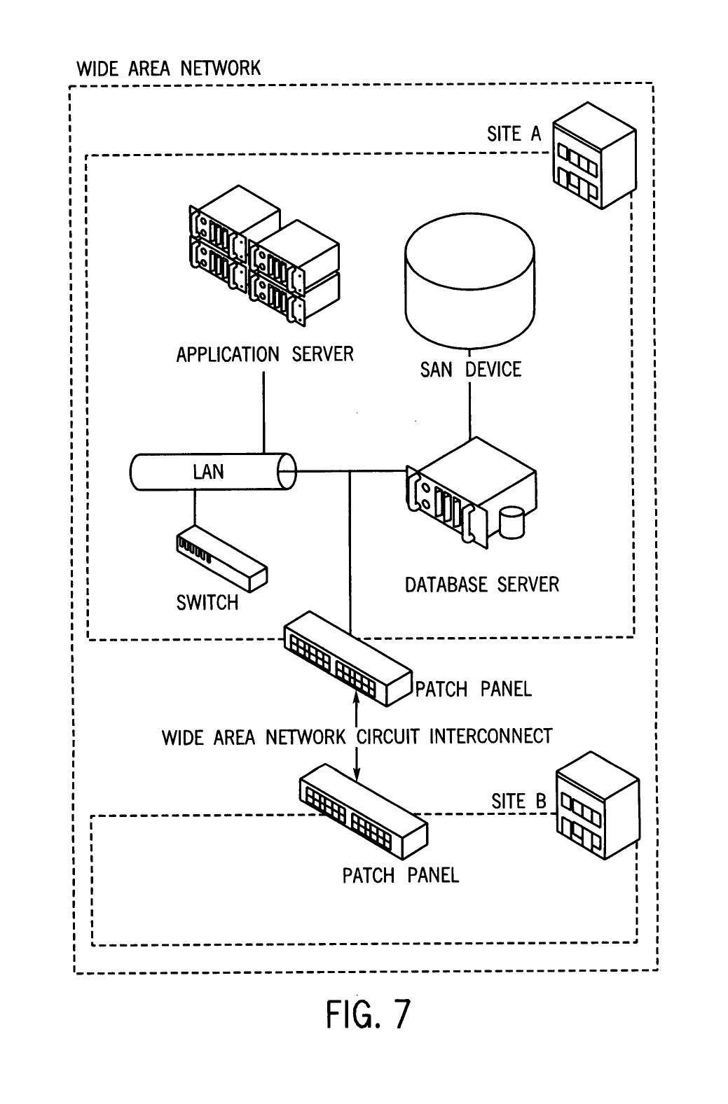

Referring to FIG. 7, a non-limiting example of a high-level hardware implementation can used to run a system of the present invention is seen. The infrastructure should include but not be limited to: wide area network connectivity, local area network connectivity, appropriate network switches and routers, electrical power (backup power), storage area network hardware, server-class computing hardware, and an operating system such as for example Redhat Linux Enterprise AS Operating System available from Red Hat, Inc, 1801 Varsity Drive, Raleigh, N.C.

The clearing and settling and administrative applications software server can run for example on an HP ProLiant DL 360 G6 server with multiple Intel Xeon 5600 series processors with a processor base frequency of 3.33 GHz, up to 192 GB of RAM, 2 PCIE expansion slots, 1 GB or 10 GB network controllers, hot plug SFF SATA drives, and redundant power supplies, available from Hewlett-Packard, Inc, located at 3000 Hanover Street, Palo Alto, Calif. The database server can be run for example on a HP ProLiant DL 380 G6 server with multiple Intel Xeon 5600 series processors with a processor base frequency of 3.33 GHZ, up to 192 GB of RAM, 6 PCIE expansion slots, 16 SFF SATA drive bays, an integrated P410i integrated storage controller, and redundant power supply, available from Hewlett-Packard.

While the invention has been described with specific embodiments, other alternatives, modifications, and variations will be apparent to those skilled in the art. For example, the principles of the present invention could be implemented as applied to a future instead of the described variance swap. Accordingly, it will be intended to include all such alternatives, modifications, and variations set forth within the spirit and scope of the appended claims.

What is claimed is:

1. A meal planning and coupon dispensing apparatus comprising:
an electronic-shopping list;
a shopping-list-item-procurement module acting as an interface between the electronic-shopping list and data on third party websites;
the shopping-list-item-procurement module parsing and extracting the data for details, the details being added to the electronic-shopping list;
the shopping-list-item-procurement module extracting from third-party websites ingredients in recipes, the ingredients being added to the electronic-shopping list;
a shopping-list-item-procurement module that analyzes the electronic-shopping list for additional savings;
the shopping-list-item-procurement module searches third-party-coupon database to locate coupons that match the items in the list;
the shopping-list-item-procurement module adds coupons that match sale items to the electronic-shopping list; and
an in-store-experience module comprising an in-store navigation map, the in-store navigation map includes an in-store application interface.

2. The meal planning and coupon dispensing apparatus of claim 1 further wherein the data on third-party websites is selected from the group comprising sales items, coupons, and combinations thereof.

3. The meal planning and coupon dispensing apparatus of claim 1 further wherein the third-party-coupon database is selected from the group comprising manufacturer coupons, coupon-provider coupons, and combinations thereof.

4. The meal planning and coupon dispensing apparatus of claim 1 further wherein the shopping-list-item-procurement module analyzes items on the electronic-shopping list to maximize savings through verification of data requirements.

5. The meal planning and coupon dispensing apparatus of claim 4 further wherein the shopping-list-item-procurement module checks the electronic-shopping list to ensure that the items and quantities match the coupon requirements.

6. The meal planning and coupon dispensing apparatus of claim 1 further wherein the shopping-list-item-procurement module analyzes generic and non-sales items for matching coupons.

7. The meal planning and coupon dispensing apparatus of claim 1 further wherein the in-store-experience module activates overlaying item locations on the in-store navigation map.

8. The meal planning and coupon dispensing apparatus of claim 1 further including utilizing analytics and heuristics to analyze the electronic-shopping list and past purchases to recommend additional products.

9. The meal planning and coupon dispensing apparatus of claim 1 further including analyzing, sorting and ranking recipes by the number of discounted ingredients.

10. The meal planning and coupon dispensing apparatus of claim 1 further including recommending off-list items based on the analysis of the current electronic-shopping list and past purchases and location within the store.

11. The meal planning and coupon dispensing apparatus of claim 1 further including best-value meals.

12. The meal planning and coupon dispensing apparatus of claim 1 further wherein the user can manually add items to the electronic-shopping list.

13. The meal planning and coupon dispensing apparatus of claim 1 further wherein previous shopping list items are sorted by frequency of purchase.

14. The meal planning and coupon dispensing apparatus of claim 1 further wherein products of which the user may be running out are added to the shopping list.

15. A method for meal planning and coupon dispensing comprising:
procuring store-specific data from at least one third-party store website;
adding the store-specific data to an electronic-shopping list;
saving recipes from at least one third-party website;
parsing a recipe for ingredients; and
adding the ingredients to the electronic-shopping list;
whereby an integrated approach for shopping list, coupon, and recipe management is provided.

16. The method for meal planning and coupon dispensing of claim 15 further including procuring store-specific data selected from the group comprising sales items, coupons, and combinations thereof.

17. The method for meal planning and coupon dispensing of claim 15 further including analyzing at least one third-party website for coupons and analyzing items on the electronic-shopping list to maximize savings through the use of third-party coupons.

18. The method for meal planning and coupon dispensing of claim 15 further including analyzing items on the electronic-shopping list to maximize savings through verification of data requirements.

19. The method for meal planning and coupon dispensing of claim 15 further including utilizing analytics and heuristics to analyze the electronic-shopping list and past purchases to recommend additional products.

20. The method for meal planning and coupon dispensing of claim 15 further including recommending off-list items based on the analysis of the current electronic-shopping list or past purchases and location within the store.

21. The method for meal planning and coupon dispensing of claim 15 further including analyzing generic items for matching coupons.

22. The method for meal planning and coupon dispensing of claim 15 further including providing an in-store navigation map.

23. The method for meal planning and coupon dispensing of claim 22 further including overlaying item locations on the in-store navigation map.

24. The method for meal planning and coupon dispensing of claim 22 further including displaying the in-store navigation map on a device selected from the group comprising a wireless telephone, a personal computer, a personal digital assistant (PDA), and a lap top computer.

25. A method for meal planning and coupon dispensing comprising:
saving recipes from at least one third-party website;
parsing a recipe for ingredients;
adding the ingredients to an electronic-shopping list;
analyzing at least one third-party website for coupons; and
analyzing items on the electronic-shopping list to maximize savings through the use of third-party coupons;
whereby an integrated approach for shopping list, coupon, and recipe management is provided.

26. The method for meal planning and coupon dispensing of claim 25 further including procuring store-specific data from at least one third-party store website and adding the store-specific data to the electronic-shopping list.

27. The method for meal planning and coupon dispensing of claim 25 further wherein the third-party-website is selected from the group comprising manufacturer website, coupon-provider third-party website, and combinations thereof.

28. The method for meal planning and coupon dispensing of claim 25 further including analyzing items on the electronic-shopping list to maximize savings through the use of third-party coupons.

29. The method for meal planning and coupon dispensing of claim 25 further including analyzing items on the electronic-shopping list to maximize savings through verification of data requirements.

30. The method for meal planning and coupon dispensing of claim 25 further including providing an in-store navigation map.
